(19) United States
(12) Patent Application Publication
(10) Pub. No.: US 2025/0105414 A1
(43) Pub. Date: Mar. 27, 2025

(54) MODULE AND/OR PACK, AND BATTERY SYSTEM MADE THEREOF

(71) Applicant: ELRINGKLINGER AG, Dettingen/Erms (DE)

(72) Inventors: André Wiechert, Dettingen/Erms (DE); Florian Schwarz, Dettingen/Erms (DE); Simon Leyhr, Dettingen/Erms (DE); Moritz Bertsch, Dettingen/Erms (DE)

(21) Appl. No.: 18/728,011

(22) PCT Filed: Oct. 7, 2022
(86) PCT No.: PCT/EP2022/077992

§ 371 Date: Jul. 10, 2024

(30) Foreign Application Priority Data
Oct. 30, 2021 (DE) 10 2021 128 402.3

(51) Int. Cl. H01M 50/213; H01M 50/227; H01M 50/503; H01M 50/509

(52) U.S. Cl. CPC H01M 50/213; H01M 50/227; H01M 50/503; H01M 50/509

(57) ABSTRACT

A pack and/or module based on elementary cells of a cylindrical design, in which the elementary cells are electrically connected to one another in series and parallel circuits by a cell contacting system, wherein a contacting of both poles of each elementary cell is provided on a free upper side of the module or pack, and to a battery system constructed therefrom, which is provided as a device for outputting and storing electrical energy. In order to produce a module and/or a pack that can be used to achieve customer-specific solutions, a carrier is spatially predefined as a module or pack format with a fixed number of elementary cells, wherein the electrical properties of the module and/or pack can be adjusted by selecting a cell contacting system with a respectively adapted interconnection of the elementary cells and these are connected on the free upper side of the module or pack.

### FIELD AND BACKGROUND OF THE INVENTION

The present invention relates to a module and/or pack based on elementary cells of a cylindrical design or round cells, in which the elementary cells are electrically connected to one another in series and parallel circuits by a cell contacting system and relates to a battery system made thereof, which is provided as a device for outputting and storing electrical energy.

It is known from the prior art that a battery system comprises at least one battery module and that several battery modules can be combined to form a pack. In principle, different cell formats can be used in battery modules. Based, for example, on U.S. Pat. No. 10,347,894 B2, the present invention focuses exclusively on a design of modules or packs that are constructed based on elementary cylindrical cells or round cells because of the comparatively high number of connection poles in a comparatively small area and correspondingly large number of possible interconnections.

According to the prior art, modules and packs based on such elementary cells or storage cells for use in vehicles generally have application-specific formats with the densest possible packing of these cells. Currently common cell formats are known, for example, by the identifiers 18650, 21700, and 46800. Application-specific formats of modules or packs based on these are used in only one application and possibly at only one location in a particular vehicle, possibly in the form of several modules in one vehicle.

Modules and packs made from cylindrical lithium-ion batteries are usually designed according to customer-specific or application-specific requirements. A customer-specific design is determined by the available installation space, particularly for applications in the passenger car sector. There are various applications for which a specific development is just not worthwhile, e.g. due to insufficient production quantities. For these applications, at least partial standardization of modules and/or packs would be advantageous since this could achieve considerable cost benefits.

The object of the present invention, therefore, is to produce a module and/or a pack that can be used to achieve customer-specific solutions without having to completely redevelop or redesign a battery system made thereof.

### SUMMARY OF THE INVENTION

In a module and/or pack that is constructed based on elementary cells of a cylindrical format in which the elementary cells are electrically connected to one another in series and parallel circuits by a cell contacting system, with a contacting of both poles of each elementary cell being provided on a free upper side of the module or pack, this object is attained according to the invention by a carrier that is spatially predefined as a module or pack format with a fixed number of elementary cells and the electrical properties of the module and/or pack are embodied so that they can be adjusted by selecting a cell contacting system with a respectively adapted interconnection of the elementary cells, which are connected on the free upper side of the module or pack. For a given geometric configuration of a module or pack, electrical properties are determined by the electrical connection of a respective cell contacting system to the elementary storage cells, where in each case a plurality of cell contacting systems can be selected to achieve different electrical properties. Establishing a change in electrical properties of the finished module or pack advantageously requires no further measures for design adaptation, in particular redesign or development of a new module or pack.

Elementary cells are connected in parallel and in series in modules in order to achieve the desired voltage level and to appropriately set the nominal current, as electrical properties. Several modules, in turn, are connected in parallel and in series in packs or energy storage units in order to achieve the desired voltage level and to appropriately set the nominal current for the respective application. One basis of the present invention is the realization that only a total number of cells, which are connected in parallel and in series in the battery system as the overall storage system, needs to be set appropriately for the application and its specifications. There are thus degrees of freedom in the selection of suitable interconnections at the cell and module level. In the context of the present invention, the degrees of freedom at the cell level are optimally utilized, not least due to the numerous poles at the cell level. Thus the only component of the module or pack that has to be adapted to a particular specification of the electrical properties, i.e. voltage level and nominal current, is the cell contacting system. Since a contacting of the two poles of each cell in such a carrier is provided on a single free upper side of the module or pack, a change in the interconnection can be made simply by appropriately changing the cell contacting system in order to set the desired electrical properties of the finished module or pack by adapting the interconnection of the energy storage units.

Accordingly, the cell contacting system is embodied as a closure of the free upper side of the pack and/or module. This makes it comparatively easy to exchange or replace one cell contacting system with another in a standardized frame before contacting with the elementary storage cells.

In a particularly advantageous modification of the invention, the carrier of the pack and/or module is embodied as a tray. The carrier thus forms a mechanical base, so to speak, of the pack or module. A mechanical support for the elementary cells provided by the carrier makes it easier to change the cell contacting system. In combination with the cell contacting system, this results in a closed, fully wired electrical unit.

Preferably, the cells are positioned upright and oriented in the same direction in the carrier. Compared to mixed forms of mounting on the carrier, this allows for greater variation in terms of the types of interconnection for influencing the electrical properties at the connection poles of the pack or module.

In one embodiment of the invention, the cell contacting system comprises a plastic carrier, which is uniform for all variants of the pack and/or module, and a grid, which is adapted to a respective specification of the electrical properties as an interconnection structure in the form of a stamped and bent structure with insulations for an interconnection of the elementary cells in the form of a specific series and parallel connection.

Advantageously, the stamped and bent structure in the cell contacting system has a secure and electrically conductive contact with terminal strips, with these terminal strips ending at two poles for the respective opposite charges.

In a modification of the invention, detachable spring contacts, resistance-welded welding tabs, metal strips, or bonded connections are provided in the region of the stamped and bent structure. This produces a secure electrical contact between the elementary cells and the cell contacting system, which is durable and reliable for any type of interconnection of the elementary storage cells by a respective cell contacting system.

Preferably, the above-mentioned metallic components of the cell contacting system are anchored to and in the plastic carrier by means of catch mechanisms and/or adhesive bonding. The cell contacting system can therefore be assembled quickly and efficiently with a high level of process reliability. The cell contacting system is selected depending on the electrical properties and requirements for a given free upper side of an assembled carrier.

In summary, modules and/or packs with single-sided contacting of both poles of each storage cell in an installation position from above or toward a free upper side enable the use of a single-sided cell contacting system, which allows a largely variably adjustable voltage and current conduction through an embodiment of a respective contact plate. Variants of a carrier for different numbers of elementary storage cells are only required for different capacities; such deviations can also be achieved within limits by means of series/parallel connection. With only one format of a mechanical carrier, which then also assumes the function of electrical insulation, a largely free choice of voltage and current with a fixed number of elementary storage cells is achieved according to the invention in order to be able to flexibly cover a wide range of applications with a uniform design and format size of a particular carrier. With a fully assembled carrier as a uniform module or pack format with a fixed number of elementary cells and thus a predetermined capacity, it is thus possible to quickly, easily, and safely change the electrical connection properties simply by selecting or changing the cell contacting system described above.

### BRIEF DESCRIPTION OF THE DRAWINGS

Further features and advantages of embodiments according to the invention will be explained in greater detail below with reference to exemplary embodiments based on the drawings. The drawings schematically depict the following:

FIG. 1: a perspective view of a tray with a base element and an outer frame adjoining one edge and terminating in an end seal;

FIG. 2: a view according to FIG. 1 of the tray progressively filled with elementary cells arranged parallel to each other and in an upright position;

FIG. 3: a perspective view of an assembly of a contact board with terminal strips and busbars to form a cell contacting system;

FIG. 4: a side view of the fully assembled cell contacting system;

FIG. 5: a top view of the frame of a module equipped with elementary cells, with the cell contacting system serving as the final cover, and

FIG. 6: an enlarged section of FIG. 5.

### DETAILED DESCRIPTION OF THE INVENTION

Throughout the various figures in the drawings, the same reference symbols are always used for the same elements or process steps. Without limiting the invention, a flat carrier is shown and described below as a block-shaped body only for an application in which embodiments of the invention are used in a battery module with cylindrical cells designed for electrically powered vehicles. The battery module is embodied to store electrical energy from any source, such as an external charging station or a generator-driven electric drive motor, and to output stored electrical energy to supply, for example, the drive motor and auxiliary and assistance systems. It is clear to the person skilled in the art, however, that adaptations to other spatial shapes are also possible in the same way, moving away from flat carriers, for example to polygonal or even curved ones for improved utilization of an existing installation space. Furthermore, adaptations to applications outside of a use in terrestrial vehicles are easily possible, especially for stationary storage devices.

In the sequence of figures described below, a module and/or pack 1 is constructed on the basis of a number of elementary cells 2 of a cylindrical format, these cells 2 being electrically interconnected in a carrier 3 by means of a cell contacting system 4 in the form of series and parallel circuits. The cell contacting system 4 is designed to be replaceable in order to change this interconnection.

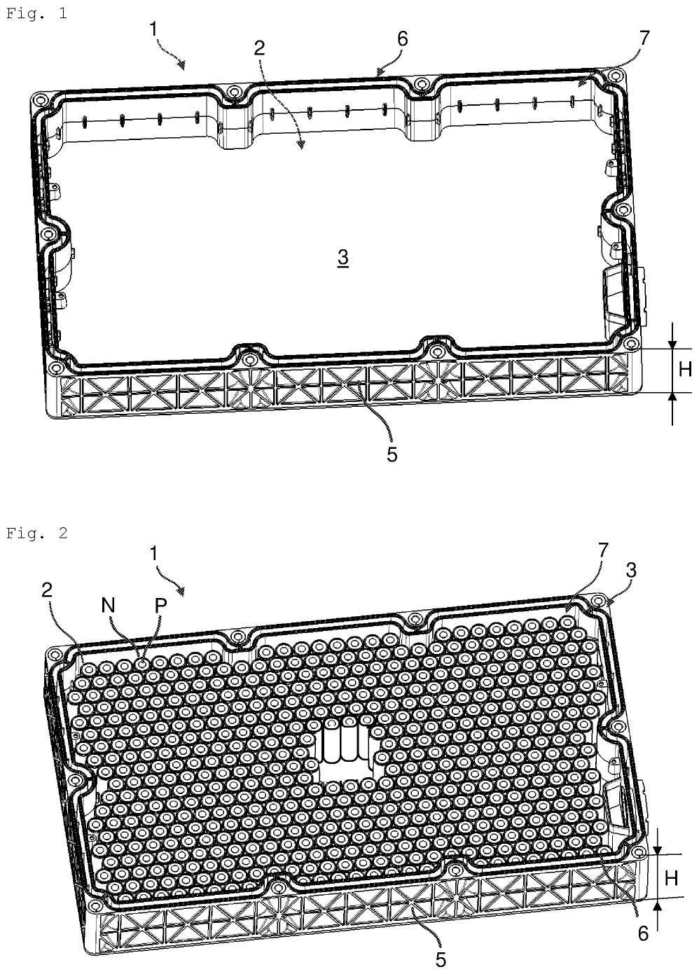

FIG. 1 shows a perspective view of a carrier 3 embodied as a tray with a seal 6 running on an edge 5 embodied as a frame. By means of struts and stiffening elements, among other things, the carrier 3 provides a mechanically resilient support for a predetermined number of elementary cells 2 of a cylindrical format, which are positioned upright and oriented in the same direction in the carrier 3. Both poles N, P of each elementary cell 2 are contacted on a free upper side 7 of the module or pack 1 in an installation position of the cells 2. A height H of the carrier 3 is matched to a length of the cylindrical format elementary cells 2 to be used such that the free upper side 7 of the module or pack 1 is produced after the cells 2 have been fitted into place. Opposite from the free upper side 7, a cooling system is provided at a bottom of the carrier 3 to dissipate waste heat generated during operation of the cells 2.

The illustration in FIG. 2 shows a view according to FIG. 1 of the carrier 3 progressively filled with elementary cells positioned upright and parallel to one another. For the sake of clarity, a central region of the carrier 3 is shown without the installed cells 2.

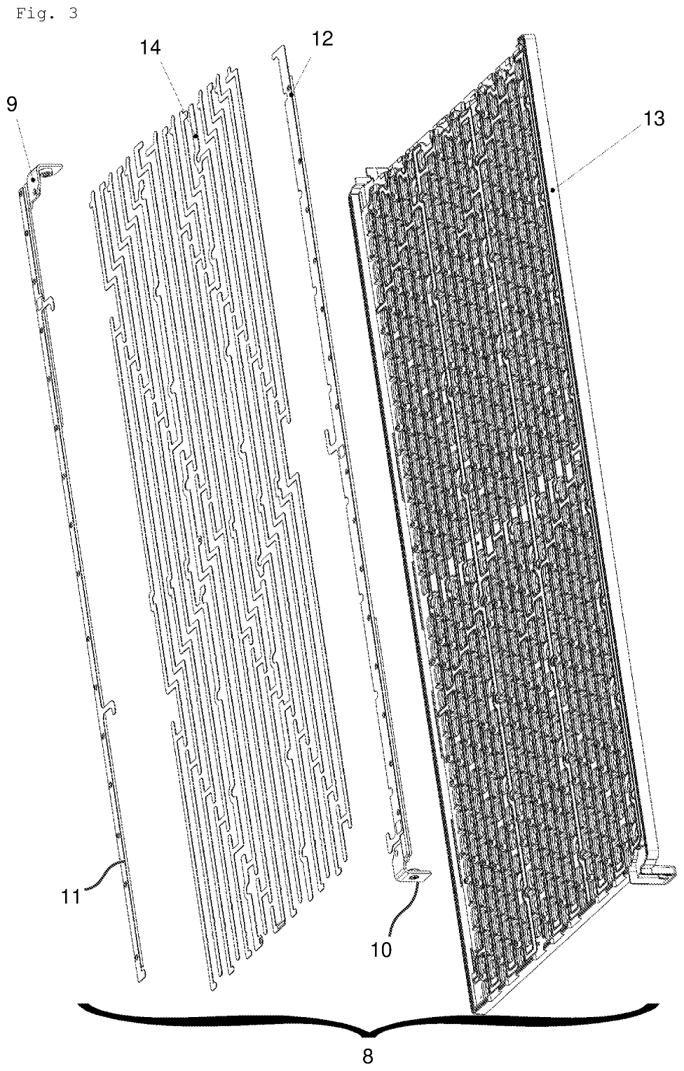

FIG. 3 shows a perspective view of an assembly of a cell contacting system 4 that is complete except for bond connectors and comprises a contact board 8 and two terminal strips 11, 12 extending into respective poles 9, 10. The contact board 8 in turn comprises a plastic carrier 13 and a grid-like stamped and bent structure 14 adapted to a respective specification of the electrical properties, which in one embodiment of the invention is provided with additional insulation in the form of adhesive dots, which is not shown in detail here. The stamped and bent structure 14 defines an interconnection of the elementary cells 2 in the form of predetermined series and parallel circuits, which achieves specified electrical properties of the selected number of elementary cells 2. In an assembled state, the stamped and bent structure 14 is in secure and electrically conductive contact with the terminal strips 11, 12. In this case, this contact is formed by welds. In this embodiment, the above-mentioned metallic components are anchored on and in the plastic carrier 13 by means of catch mechanisms.

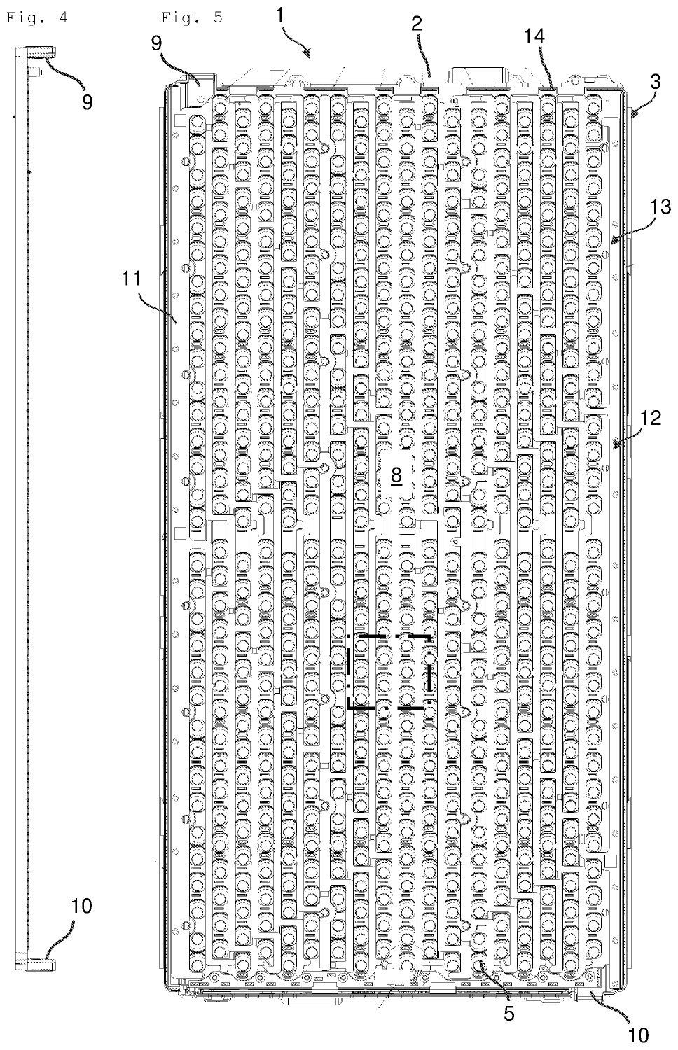

FIG. 4 shows a side view of the fully assembled cell contacting system 4. In the form of metallic components assembled around the stamped and bent structure 14 in the very flat contact board 8 in the plastic carrier 13, the cell contacting system 4 forms a compact and mechanically stable component that extends into the poles 9, 10.

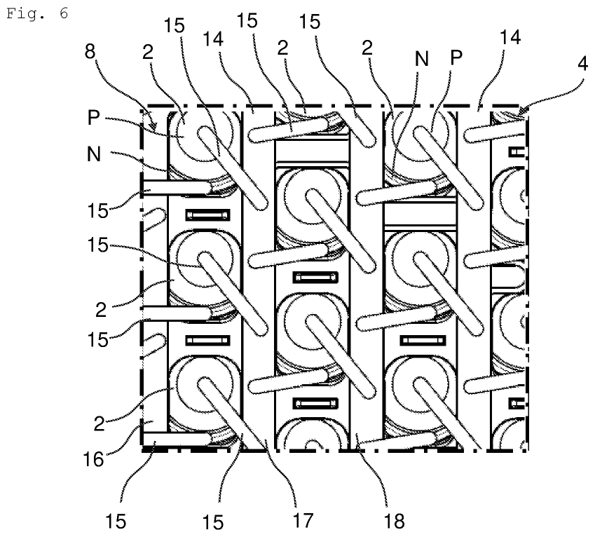

FIG. 5 shows a top view of the cell contacting system 4 in the form of the contact board 8 as a cover on the carrier 3 of the module or pack 1 equipped with elementary cells 2. By anchoring the contact board 8 by screwing and/or gluing it to the edge 5 of the carrier, a permanent mechanical unit is formed, which in this case is also embodied as sealed. The cell contacting system 4 can now be electrically connected to the poles of the elementary cells 2 via bond connections or, for example, also via spring contacts formed onto the grid-like stamped and bent structure 14.

Finally, FIG. 6 shows a section of FIG. 5 to better show the electrical connection at the level of the elementary storage cells 2. As already indicated above, the connections for both polarities N, P of the elementary storage cells 2 are located together on the free upper side 7 of the carrier 3. A central positive contact pole P is used as the first connection. An insulated, electrically conductive outer housing is used as the negative second pole N. In FIG. 5, the contact board 8 has already been placed onto the carrier 3 and anchored in place. FIG. 6 now shows in detail how the grid-like stamped and bent structure 14 positioned in the plastic carrier 13 of the contact board 8 is respectively connected to the positive contact poles P and negative poles N by means of bonding wire connections 15. A conductor 16 of the grid-like stamped and bent structure 14 of the contact board 8 is electrically connected to the negative pole N of an elementary storage cell 2 by welding at its two ends via a bonding wire connection 15, with the associated positive contact pole P of the same elementary storage cell 2 being conductively connected to a further conductor 17 of the grid-like stamped and bent structure 14 via a further bonding wire connection 15. From the conductor 17, it then continues in an analogous manner via bond-wire connections 15 to neighboring elementary storage cells 2 so that the elementary storage cells 2 here are connected in parallel row by row and in series column by column, i.e. are connected to the same potential.

With such a device, storage systems or the components thereof with very different electrical properties can now be implemented with the same number of elementary storage cells 2. There is basically no restriction on the number of cells 2 in a carrier 3 of a module or pack 1 within the scope of the present invention. In order to retain as much flexibility as possible with regard to setting different current and voltage values, however, it is advisable to select integer multiples of 2 for the number of cells 2. Common round cell formats are currently 18650, 21700, and 46800, for example, but all round cells can be handled in the above-described manner in accordance with a teaching according to the invention. If a module size of 288 cells of type 21700 is selected in a first numerical example, then a 5 kWh module, e.g. for plug-in hybrids with a nominal voltage of 200 V, can be produced in a pack or module 1, for example by means of a 48s6p connection, i.e. 48 serial strings of elementary cells 2 in a 6-fold parallel connection. This module can be connected in series or parallel to form a plug-in battery of suitable capacity purely by modifying or replacing the cell contacting system CCS 4. When a plastic carrier 13 with a carrier 3 as a standardized subassembly is used, only the grid-like stamped and bent structure 14 needs to be adapted accordingly. Therefore, a second example based on the above-mentioned module size of 288 cells of type 21700 is a module with less than 60 V maximum voltage—for reasons of employee protection—in the form of a 16s18p circuit as the basis for a traction storage of a battery-powered electric vehicle, BEV, e.g. in a 12s24p or 8s36p circuit when divided into several modules connected in series. With the above-mentioned module size, good space utilization could be achieved in various applications. The only component of the module that has to be adapted to a particular specification of the electrical properties is the cell contacting system, which consists of a uniform plastic carrier for all module variants and a grid-like stamped structure adapted to the module type for the selected module interconnection in the form of a specific series and parallel connection of the cells.

In the context of the present invention, it is thus possible in particular to decisively change the electrical connection properties of a fully assembled module or pack when it is delivered or stored after completion as a closed and tested module or pack, e.g. with spring contacting of the cell contacting system CCS to the elementary storage cells. And for this predetermined change, it is only necessary to select a different cell contacting system 4 with a correspondingly adapted circuit, which is placed as a cover onto a free upper side 7 of the fully assembled carrier 3 of the module or pack 1 and preferably connected to it via bonded connections 15. This enables a largely free choice of voltage and current as electrical properties for a given capacitance, without changing any other module or pack components, with the aim of being able to cover a wide range of applications on a standardized basis of a carrier format in the form of a carrier or frame 3, without requiring extensive design modifications or even an entirely new design.

As an alternative to a pack structure composed of individual modules, this technology can also be used to create ‘cell to pack’ or ‘cell to chassis’ concepts by means of suitable series and parallel connection of groups of elementary cells from packs or modules of the type shown above. The advantages of these concepts are an optimized utilization of installation space by a battery system with a maximum degree of variability, whereby the total weight and also the total costs of the modules or packs proposed above are comparatively reduced by reducing the number of module components required while improving the utilization of space. An application of a cell contacting system 4 according to the invention also enables a largely flexible adaptation of a frame 3, which is equipped as a carrier with elementary storage cells 2 ready for one-sided contacting on a free upper side 7, to changed electrical properties of the relevant pack or module 1 at external connections of its poles 9, 10.

1. A module and/or pack comprising:
a plurality of elementary cells of a cylindrical design, wherein the elementary cells are electrically connected to one another in series and parallel circuits by a cell contacting system, and wherein a contacting of both positive and negative poles of each of the plurality of elementary cells is provided on a free upper side of the module or pack, and
a carrier that is spatially predefined as a module or pack format with a fixed number of the plurality of elementary cells, wherein the electrical properties of the module and/or pack are adjusted by selecting the cell contacting system with a respectively adapted interconnection of the fixed number of the plurality of elementary cells and the fixed number of the plurality of elementary cells are connected on the free upper side of the module or pack.

2. The module and/or pack according to claim 1, wherein the cell contacting system is a closure of the free upper side of the pack and/or module.

3. The module and/or pack according to claim 1, wherein the carrier of the pack and/or module is a tray.

4. The module and/or pack according to claim 1, wherein the fixed number of the plurality of elementary cells are positioned upright and oriented in the same direction in the carrier.

5. The module and/or pack according to claim 1, wherein the cell contacting system comprises a plastic carrier, which is uniform for all variants of the pack and/or module, and a grid-like stamped and bent structure, which is adapted to a respective specification of the electrical properties and has insulations for an interconnection of the fixed number of the plurality of elementary cells in the form of a specific series and parallel interconnection which has two poles.

6. The module and/or pack according to claim 5, wherein the stamped and bent structure in the cell contacting system has a secure and electrically conductive contact with terminal strips, which end at the two poles.

7. The module and/or pack according to claim 5, wherein at least one of the group consisting of: detachable spring contacts, resistance-welded welding tabs, metal strips, and bonded connections are provided in a region of the stamped and bent structure for a secure electrical contact between the fixed number of the plurality of elementary cells and the cell contacting system.

8. The module and/or pack according to claim 5, wherein metallic components of the cell contacting system are anchored to and in the plastic carrier by catch mechanisms and/or adhesive bonding.

9. The module and/or pack according to claim 1, wherein a number of the plurality of cells in the carrier of a module or pack is an integer multiple of 2.

10. A battery system, which is provided as a device for outputting and storing electrical energy,
wherein the battery system comprises a plurality of the packs and/or modules according to claim 1, which are electrically connected or interconnected in a series and/or parallel configuration.
